(19) United States
(12) Patent Application Publication
(10) Pub. No.: US 2007/0010579 A1
(43) Pub. Date: Jan. 11, 2007

(54) Copper salts of organic acids and use thereof as fungicides

(76) Inventor: Marilena Gusmeroli, Monza-Milano (IT)

Correspondence Address: HEDMAN & COSTIGAN P.C., 1185 AVENUE OF THE AMERICAS, NEW YORK, NY, 10036, US

(21) Appl. No.: 10/556,013

(22) PCT Filed: May 8, 2004
(86) PCT No.: PCT/EP04/05490

§ 371 Date: Sep. 1, 2006

(30) Foreign Application Priority Data
May 21, 2003 (IT) MI2003A001020

(51) Int. Cl. A01N 55/02

(52) U.S. Cl. 514/499

(57) ABSTRACT

Compounds are described, having general formula (I): A·Cu wherein A represents the bibasic ion of an organic acid which can have the meanings (A₁)-(A₈) and Cu represents the copper 2+ ion; and the use of compounds having formula (I), individually or in a mixture, for the control of bacterial and fungal phytopathogens on vegetables or parts thereof.

The present invention relates to the use of copper salts of organic acids for the control of phytopathogen fungi.

Inorganic copper salts, such as, for example, sulfates, oxychlorides, hydroxides, carbonates and the well-known Bordeaux mixture, have been widely used in agriculture for the control of fungal diseases in preventive applications.

It is also known that copper salts of organic acids such as, for example, copper acetate, copper succinate, copper glutarate, copper adipate, copper citrate, copper tartrate, copper aspartate, copper glutamate, copper phthalates, copper benzoates, can be used for the control of fungal diseases in agricultural crops, optionally mixed with other active principles, as described, for example, in JP7398021; or in Pesticide (1980), vol. 14(10), pages 29-30; or in Geobios (1985), vol. 12(3-4), pages 147-8.

The Applicant has now found that copper salts of some particular organic acids allow a prolonged protective action to be obtained on vegetables, which is higher than that of the copper salts described above and with much lower doses.

The use of these salts in agronomic practice therefore allows, with respect to the previously known organic or inorganic copper derivatives, a reduction in the copper content in the formulates applied with significant beneficial repercussions on the environmental impact.

The Applicant has also found that these salts are an excellent form of controlling phytopathogens also in vegetable varieties genetically modified to amplify the original natural defense mechanism.

Furthermore, the Applicant has found that these salts can also be used for the control of fungal diseases on non-living substrates such as, for example, plastics, metals, textile fibres, glass, wood, paper, foams, bricks, etc. These salts can be applied on the surface of the substrate by methods well-known in the art, such as spraying, painting, immersion, impregnation, etc. at application doses depending on the nature of the material and conditions to which the substrate is subjected.

Many of these copper salts are new; others are known, but their use has never been described for these particular applications.

An object of; the present invention therefore relates to the use of compounds having general formula (I):
A·Cu (I)
wherein:

A represents the bibasic ion of an organic acid which can have the meanings (A₁)-(A₈);

Cu represents the copper 2+ion;

(A₁)-(A₈) respectively represent the following carboxylic acids: 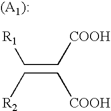
wherein:

R₁ and R₂, the same or different, represent a hydrogen atom; a C₁-C₆ alkyl or C₁-C₆ haloalkyl group, linear or branched, optionally substituted; a C₂-C₆ alkenyl or C₂-C₆ haloalkenyl group, linear or branched, optionally substituted; a C₃-C₆ cycloalkyl group, optionally substituted; a C₁-C₆ alkoxyl or C₁-C₆ haloalkoxyl group, linear or branched, optionally substituted; a C₁-C₆ alkylthio or C₁-C₆ haloalkylthio group, linear or branched, optionally substituted; a C₃-C₆ cycloalkoxyl group, optionally substituted; an aryl group optionally substituted or a heteroaryl group optionally substituted; a heterocyclic group optionally substituted; 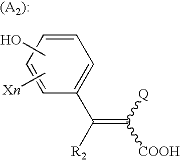
Wherein:

R₂ has the meanings defined above;

Q represents a hydrogen atom; a C₁-C₆ alkyl or C₁-C₆ haloalkyl group, linear or branched, optionally substituted; a cyano group; a C₁-C₆ alkylcarbonyl or C₁-C₆ haloalkylcarbonyl group, linear or branched, optionally substituted; a C₁-C₆ alkoxycarbonyl group, linear or branched, optionally substituted; an aminocarbonyl group; a C₁-C₆ alkylaminocarbonyl group; a C₂-C₁₂ dialkylaminocarbonyl group;

X represents a hydrogen atom or a halogen atom; a hydroxyl group; a C₁-C₆ alkyl or C₁-C₆ haloalkyl group, linear or branched, optionally substituted; a C₁-C₆ alkoxyl or C₁-C₆ haloalkoxyl group, linear or branched, optionally substituted; a cyano group; a nitro group; an amine group; a C₁-C₆ alkylamine group; a C₂-C₁₂ dialkylamine group; a C₁-C₆ linear or branched thioalkyl group, possibly substituted; a C₁-C₆ linear or branched halothioalkyl group, possibly substituted; a C₁-C₆ linear or branched alkylsulfinyl group, possibly substituted; a C₁-C₆ linear or branched alkylsulfonyl group, possibly substituted;

n is a number ranging from 1 to 4; 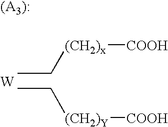
wherein:

W represents an oxygen atom; a C₁-C₆ alkylimine group, linear or branched, optionally substituted; an arylimine group optionally substituted; a heteroarylimine group optionally substituted; a C₁-C₆ alkoxyimine group, linear or branched, optionally substituted; an aryloxyimine group optionally substituted;
x and y, the same or different, are a number ranging from 0 to 4; 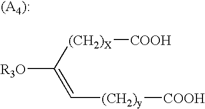
   wherein:

R₃ represents a C₁-C₆ alkyl or C₁-C₆ haloalkyl group, linear or branched, optionally substituted; a C₃-C₆ cycloalkyl group, optionally substituted; an aryl group, optionally substituted; a heteroaryl group, optionally substituted;

x and y, the same or different, are a number ranging from 0 to 4; 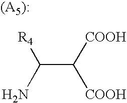
wherein:

R₄ represents a C₁-C₆ alkyl or C₁-C₆ haloalkyl group, linear or branched, optionally substituted; a C₃-C₆ cycloalkyl group, optionally substituted; an aryl group, optionally substituted; a heteroaryl group, optionally substituted; 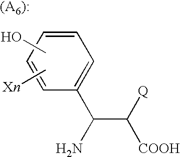
wherein:

Q, X and n have the same meanings defined above; 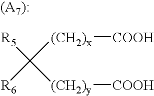
wherein:

R₅ and R₆, the same or different, represent a hydrogen atom; a halogen atom; a C₁-C₆ alkyl or C₁-C₆ haloalkyl group, linear or branched, optionally substituted; a C₂-C₆ alkenyl or C₂-C₆ haloalkenyl group, linear or branched, optionally substituted; a C₂-C₆ alkinyl or C₂-C₆ haloalkinyl group, linear or branched, optionally substituted; a C₃-C₆ cycloalkyl group, optionally substituted; a C₁-C₆ alkoxyl or C₁-C₆ haloalkoxyl group, linear or branched, optionally substituted; a C₁-C₆ alkylthio or C₁-C₆ haloalkylthio group, linear or branched, optionally substituted; a C₃-C₆ cycloalkoxyl group, optionally substituted; a C₁-C₆ alkylamine group, linear or branched, optionally substituted; a C₂-C₁₂ dialkylamine group, linear or branched, optionally substituted; a C₁-C₆ alkylcarbonylamine group, linear or branched, optionally substituted; an arylcarbonylamine group, optionally substituted; an aryl group, optionally substituted; a heteroaryl group, optionally substituted; a heterocyclic group, optionally substituted;

R₅ and R₆ can jointly form a C₁-C₆ cycle;

x and y, the same or different, are a number ranging from 0 to 4 excluding cases wherein x and y are a number ranging from 0 to 2 and R₅ and R₆ are both a hydrogen atom; 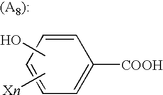
wherein

X and n have the same meanings described above excluding salicylic acid; alone or in a mixture, for the control of bacterial and fungal phytopathogens on vegetable or parts thereof.

A C₁-C₆ alkyl group refers to a linear or branched C₁-C₆ alkyl group, optionally substituted by one or more substituents, the same or different.

Examples of this group are: methyl, ethyl, propyl, isopropyl, butyl, isobutyl, tert-butyl.

A C₁-C₆ haloalkyl group refers to a linear or branched C₁-C₆ alkyl group, optionally substituted by one or more halogen atoms, the same or different.

Examples of this group are: fluoromethyl, difluoromethyl, trifluoromethyl, trichloromethyl, 2,2,2-trifluoroethyl, 2,2,2-trichloroethyl, 2,2,3,3-tetrafluoropropyl, 2,2,3,3,3-pentafluoropropyl.

A C₂-C₆ alkenyl group refers to a linear or branched C₂-C₆ alkenyl group, optionally substituted by one or more substituents, the same or different.

Examples of this group are: ethenyl, propenyl, butenyl.

A C₂-C₆ haloalkenyl group refers to a linear or branched C₂-C₆ alkenyl group, optionally substituted by one or more halogen atoms, the same or different.

Examples of this group are: 2,2-dichloropropenyl, 1,2,2-trichloropropenyl.

A C₂-C₆ alkinyl group refers to a linear or branched C₂-C₆ alkinyl group, optionally substituted by one or more substituents, the same or different.

Examples of this group are: ethenyl, propargyl.

A C₂-C₆ haloalkinyl group refers to a linear or branched C₂-C₆ alkinyl group, optionally substituted by one or more halogen atoms, the same or different.

Examples of this group are: 3-chloropropinyl.

A C₃-C₆ cycloalkyl group refers to a cycloalkyl group whose ring consists of 3-6 carbon atoms, optionally substituted by one or more substituents, the same or different.

Examples of this group are: cyclopropyl, 2,2-dichlorocyclopropyl, cyclobutyl, cyclopentyl, cyclohexyl.

A C₁-C₆ alkoxyl group refers to a C₁-C₆ alkoxyl group, wherein the aliphatic portion is a C₁-C₆ alkyl group, as described above.

Examples of this group are: methoxyl, ethoxyl, isopropoxyl, cyclopropyl methoxyl.

A C₁-C₆ haloalkoxyl group refers to a C₁-C₆ haloalkoxyl group, wherein the aliphatic portion is a C₁-C₆ haloalkyl group, as described above.

Examples of this group are: trifluoromethoxyl, 1,1,2,2-tetrafluoroethoxyl, 1,1,2,3,3,3-hexafluoropropyloxyl.

A C₁-C₆ thioalkyl group refers to a C₁-C₆ thioalkyl group, wherein the aliphatic portion is a C₁-C₆ alkyl group, as described above.

Examples of this group are: thiomethyl, thioethyl.

A C₁-C₆ halothioalkyl group refers to a C₁-C₆ halothioalkyl group, wherein the aliphatic portion is a C₁-C₆ haloalkyl group, as described above. Examples of this group are: trifluorothiomethoxyl, 1,1,2,2-tetrafluorothioethoxyl.

A C₁-C₆ alkylsulfinyl group refers to a C₁-C₆ alkylsulfinyl group, wherein the aliphatic portion is a C₁-C₆ alkyl group, as described above.

Examples of this group are: methylsulfinyl, ethylsulfinyl.

A C₁-C₆ alkylsulfonyl group refers to a C₁-C₆ alkylsulfonyl group, wherein the aliphatic portion is a C₁-C₆ alkyl group, as described above.

Examples of this group are: methylsulfonyl, ethylsulfonyl.

A C₃-C₆ cycloalkoxyl group refers to a C₃-C₆ cycloalkoxyl group, wherein the aliphatic portion is a C₃-C₆ cycloalkyl group, as described above. Examples of this group are: cyclopentoxy, cyclohexyloxy.

A C₁-C₆ alkylamine or C₂-C₁₂ dialkylamine group refers to an alkylamine or dialkylamine group wherein the aliphatic portion is one or two C₁-C₆ alkyl groups as defined above.

Examples of this group are: methylamino, dimethylamino, ethylamino, isopropylamino, dibutylamino.

An aryl group refers to an aromatic carbocyclic group optionally substituted by one or more groups, the same or different.

Examples of this group are: phenyl, naphthyl.

A heteroaryl group refers to an aromatic penta or hexatomic heterocyclic group, also benzocondensed or heterobicyclic, containing from 1 to 4 heteroatoms selected from nitrogen, oxygen, sulfur, optionally substituted by one or more groups, the same or different.

Examples of heteroaryl groups are: pyridine, pyrimidine, pyridazine, pyrazine, triazine, tetrazine, quinoline, quinoxaline, quinazoline, furan, thiophene, pyrrol, oxazole, thiazole, isoxazole, isothiazole, oxadiazole, thiadiazole, pyrazole, imidazole, triazole, tetrazole, indole, benzofuran, benzothiophene, benzoxazole, benzothiazole, benzoxadiazole, benzothiadiazole, benzopyrazole, benzimidazole, benzotriazole, triazolepyridine, triazolepyrimidine, thiazoletriazole.

A heterocyclic group refers to a saturated or unsaturated ring with from three to twelve elements, containing at least one heteroatom selected from nitrogen, oxygen, sulfur, optionally condensed with another aromatic or non aromatic ring.

Examples of heterocyclic rings are: pyrrolidine, piperidine, dihydropyridine, piperazine, 2,6-diketopiperazine, 2-ketoazetidine, morpholines, thiazine, indoline.

A C₁-C₆ alkylimine group refers to an alkylimine group wherein the aliphatic portion is a C₁-C₆ alkyl group as defined above.

Examples of this group are: ethylimine, isopropylimine, benzylimine, 1-phenylethylimine.

An arylimine and heteroarylimine group refers to an arylimine and heteroarylimine group wherein the aromatic and heteroaromatic portion are an aryl group and a heteroaryl group respectively as defined above.

Examples of this group are: phenylimine, naphthylimine, 2-pyridylimine, 4-pyridylimine, 2-pyrimidylimine, 2-thienylimine, 2-thiazolylimine.

A C₁-C₆ alkoxyimine group refers to an alkoxyimine group wherein the alkoxyl portion is a C₁-C₆ alkoxyl group as defined above.

Examples of this group are: methoxylimine, ethoxyimine, isopropoxylimine, benzyloxylimine.

An aryloxyimine group refers to an aryloxyimine group wherein the aromatic portion is an aryl group as defined above.

Examples of this group are: phenoxyimine, naphthoxyimine.

A C₁-C₆ alkycarbonylamine group refers to an alkylcarbonylamine group wherein the aliphatic portion is a C₁-C₆ alkyl group as defined above.

Examples of this group are: acetylamine, propylcarbonylamine.

An arylcarbonylamine group refers to an arylcarbonylamine group wherein the aromatic portion is an aryl group as defined above.

Examples of this group are: benzoylamine, 4-methylbenzoylamine.

A C₁-C₆ alkylcarbonyl group refers to an alkylcarbonyl group wherein the aliphatic portion is a C₁-C₆ alkyl group as defined above.

Examples of this group are: acetyl, ethylcarbonyl, isopropylcarbonyl.

A C₁-C₆ haloalkylcarbonyl group refers to a haloalkylcarbonyl group wherein the aliphatic portion is a C₁-C₆ haloalkylgroup as defined above.

Examples of this group are: 1,1,1-trifluoromethylcarbonyl.

A C₁-C₆ alkoxy carbonyl group refers to an alkoxycarbonylgroup wherein the aliphatic portion is a C₁-C₆ alkoxyl group as defined above.

Examples of this group are: methoxylcarbonyl, ethoxycarbonyl, isopropoxylcarbonyl, butoxycarbonyl, benzyloxycarbonyl.

A C₁-C₆ alkylaminocarbonyl or C₂-C₁₂ dialkylaminocarbonyl group refers to an alkylaminocarbonyl or dialkylaminocarbonyl group wherein the aliphatic portion is one or two C₁-C₆ alkyl groups respectively, as defined above.

Examples of this group are: methylaminocarbonyl, dimethylaminocarbonyl, ethylaminocarbonyl, isopropylaminocarbonyl, dibutylaminocarbonyl.

Optionally substituted, in all parts of the patent, refers to one or more substituents, the same or different, selected from the following groups: halogen atoms; C₁-C₆ alkyls, C₁-C₆ alkoxyls, and C₁-C₆ alkylthio, C₁-C₆ alkylsulfinyl and C₁-C₆ alkylsulfonyl, in turn optionally substituted by halogen atoms; C₁-C₆ alkyl carbonyls and C₁-C₆ alkoxycarbonyls, optionally halogenated; aminocarbonyls, C₁-C₆ alkylaminocarbonyls, C₂-C₁₂ dialkylaminocarbonyls, optionally halogenated; carboxyl; C₁-C₆ alkylcarbonyloxy optionally halogenated; cyano; nitro; formyl; hydroxyl; amino; aryl and heteroaryl, optionally substituted.

Examples of compounds having general formula (I) which are interesting for their activity are:

copper (II) salt of 4-chlorobenzylidenemalonic acid;

copper (II) salt of 4-hydroxy-3-methoxybenzylidene malonic acid;

copper (II) salt of 3,4-dimethoxybenzylidenemalonic acid;

copper (II) salt of 4-fluorobenzylidenemalonic acid;

copper (II) salt of 4-trifluoromethylbenzylidenemalonic acid;

copper (II) salt of 4-dimethylaminobenzylidenemalonic acid;

copper (II) salt of 2,4-dichlorobenzylidenemalonic acid;

copper (II) salt of 4-bromobenzylidenemalonic acid;

copper (II) salt of 4-hydroxy-3-methoxybenzylidene malonic acid monomethyl ester;

copper (II) salt of 4-hydroxy-3-methoxybenzylidenemalonic acid monoethyl ester;

copper (II) salt of 2-cyano-3-(4-hydroxy-3-methoxyphenyl)propenoic acid;

copper (II) salt of 2-acetyl-3-(4-hydroxy-3-methoxyphenyl)propenoic acid;

copper (II) salt of 2-aminocarbonyl-3-(4-hydroxy-3-methoxyphenyl)propenoic acid;

copper (II) salt of 3-(4-hydroxy-3-methoxyphenyl)-2-methoxycarbonyl-2-butenoic acid;

copper (II) salt of 4-hydroxy-3-methoxy cinnamic acid;

copper (II) salt of 2-hydroxycinnamic acid;

copper (II) salt of 3-hydroxycinnamic acid;

copper (II) salt of 4-hydroxycinnamic acid;

copper (II) salt of 3-ketoglutaric acid;

copper (II) salt of 3-methoxy-2-pentendioic acid;

copper (II) salt of 3-amino-2-carboxy-3-(4-chlorophenyl)propanoic acid;

copper (II) salt of 3-amino-2-carboxy-3-(2-hydroxy-phenyl)propanoic acid;

copper (II) salt of 3-amino-2-carboxy-3-(4-trifluoro methylphenyl)propanoic acid;

copper (II) salt of 3-amino-2-carboxy-3-(4-hydroxy-3-methoxyphenyl)propanoic acid;

copper (II) salt of 3-amino-2-carboxy-3-(3,4-dimethoxyphenyl)propanoic acid;

copper (II) salt of 3-amino-3-(2-hydroxyphenyl)propanoic acid;

copper (II) salt of 3-amino-3-(4-hydroxy-3-methoxyphenyl)propanoic acid;

copper (II) salt of 3-amino-2-cyano-3-(4-hydroxyphenyl)propanoic acid;

copper (II) salt of 3-amino-2-cyano-3-(4-hydroxy-3-methoxyphenyl)propanoic acid;

copper (II) salt of 2-methoxysuccinic acid;

copper (II) salt of 2-ethoxysuccinic acid;

copper (II) salt of 3-(2-furyl)-2-carboxypropenoic acid;

copper (II) salt of 3-(2-thiazolyl)-2-carboxypropenoic acid;

copper (II) salt of 3-benzylidene-2-carboxypropenoic acid;

copper (II) salt of 1,1-cyclopropane dicarboxylic acid;

copper (II) salt of diallylmalonic acid;

copper (II) salt of ethylphenyl malonic acid;

copper (II) salt of bis(2-cyano ethyl)malonic acid;

copper (II) salt of N-morpholine malonic acid;

copper (II) salt of N-benzyloxyimino malonic acid;

copper (II) salt of 3-hydroxy benzoic acid;

copper (II) salt of 4-hydroxy benzoic acid;

copper (II) salt of 5-chloro-2-hydroxy benzoic acid;

copper (II) salt of 5-bromo-2-hydroxy benzoic acid;

copper (II) salt of 2-hydroxy-3-methoxy benzoic acid;

copper (II) salt of 2-hydroxy-5-methoxy benzoic acid;

copper (II) salt of 2-hydroxy-3-methyl benzoic acid;

copper (II) salt of 4-hydroxy-3-methoxy benzoic acid;

copper (II) salt of 3,5-dimethoxy-4-hydroxy benzoic acid;

copper (II) salt of 3,5-dichloro-4-hydroxy benzoic acid;

copper (II) salt of 3,5-dibromo-4-hydroxy benzoic acid;

copper (II) salt of 3,5-dimethyl-4-hydroxy benzoic acid;

copper (II) salt of 3-chloro-4-hydroxy benzoic acid;

copper (II) salt of 2,3-dihydroxy benzoic acid;

copper (II) salt of 2,6-dihydroxy benzoic acid;

copper (II) salt of 3,4-dihydroxy benzoic acid.

An object of the present invention also relates to the use of the compounds having general formula (I) for the control of fungal phytopathogens on non-living substrates such as plastics, metals, textile fibres, glass, wood, paper, foams, bricks.

As specified above, many of the salts of formula (I) are new products.

A further object of the present invention therefore relates to the compounds having general formula (I′):
A′·Cu (I′)
wherein:

A′ represents the bibasic ion of an organic acid which can have the meanings (A′₁)-(A′₇);

Cu represents the copper 2+ion;

(A′₁)-(A′₇) respectively represent the following carboxylic acids: 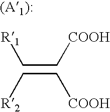
wherein:

R′₁ represents an aryl group optionally substituted;

R′₂ represents a hydrogen atom; 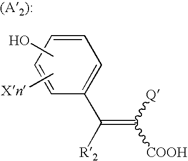
wherein:

X′ represents a hydrogen or halogen atom; a hydroxyl group; a C₁-C₆ alkoxyl group, linear or branched, optionally substituted;

n′ can have the value of 1 or 2;

R′₂ represents a hydrogen atom;

Q′ represents a hydrogen atom; a C₁-C₆ alkoxycarbonyl group, linear or branched, optionally substituted; an acetyl group; a cyano group; 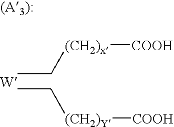
wherein:

W′ represents an oxygen atom;

x′ and y′ both have the value of 1; 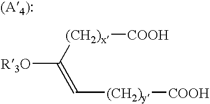
wherein:

R′₃ represents a C₁-C₃ alkyl group, linear or branched;

x′ is equal to 1 and y′ is equal to 0; 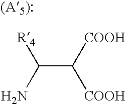
wherein:

R′₄ represents an aryl group, optionally substituted; 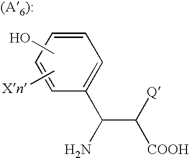
wherein:

X′ represents a hydrogen or halogen atom; a hydroxyl group; a C₁-C₆ alkoxyl group, linear or branched, optionally substituted;

n′ can have the value of 1 or 2;

Q₁ represents a hydrogen atom; a C₁-C₆ alkoxycarbonyl group, linear or branched, optionally substituted; an acetyl group; a cyano group; 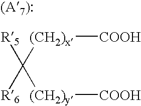
wherein:

R′₅ represents a C₁-C₆ alkoxyl group, linear or branched;
R′₆ represents a hydrogen atom;
x′ is equal to 0 and y′ is equal to 1.

Examples of products having general formula (I′) which have never been described before are:

copper (II) salt of 4-chlorobenzylidenemalonic acid;

copper (II) salt of 4-hydroxy-3-methoxybenzylidene malonic acid;

copper (II) salt of 3,4-dimethoxybenzylidene malonic acid;

copper (II) salt of 4-fluorobenzylidene malonic acid;

copper (II) salt of 4-trifluoromethylbenzylidene malonic acid;

copper (II) salt of 4-dimethylaminobenzylidene malonic acid;

copper (II) salt of 2,4-dichlorobenzylidene malonic acid;

copper (II) salt of 4-bromobenzylidene malonic acid;

copper (II) salt of 4-hydroxy-3-methoxybenzylidene malonic acid monomethyl ester;

copper (II) salt of 4-hydroxy-3-methoxybenzylidene malonic acid monoethyl ester;

copper (II) salt of 2-cyano-3-(4-hydroxy-3-methoxyphenyl)propenoic acid;

copper (II) salt of 2-acetyl-3-(4-hydroxy-3-methoxyphenyl)propenoic acid;

copper (II) salt of 2-aminocarbonyl-3-(4-hydroxy-3-methoxyphenyl)propenoic acid;

copper (II) salt of 3-(4-hydroxy-3-methoxyphenyl)-2-methoxycarbonyl-2-butenoic acid;

copper (II) salt of 4-hydroxy-3-methoxy cinnamic acid;

copper (II) salt of 2-hydroxycinnamic acid;

copper (II) salt of 3-hydroxycinnamic acid;

copper (II) salt of 4-hydroxycinnamic acid;

copper (II) salt of 3-ketoglutaric acid;

copper (II) salt of 3-methoxy-2-pentendioic acid;

copper (II) salt of 3-amino-2-carboxy-3-(4-chlorophenyl)propanoic acid;

copper (II) salt of 3-amino-2-carboxy-3-(2-hydroxy-phenyl)propanoic acid;

copper (II) salt of 3-amino-2-carboxy-3-(4-trifluoromethylphenyl)propanoic acid;

copper (II) salt of 3-amino-2-carboxy-3-(4-hydroxy-3-methoxyphenyl)propanoic acid;

copper (II) salt of 3-amino-2-carboxy-3-(3,4-dimethoxyphenyl)propanoic acid;

copper (II) salt of 3-amino-3-(2-hydroxyphenyl)propanoic acid;

copper (II) salt of 3-amino-3-(4-hydroxy-3-methoxyphenyl)propanoic acid;

copper (II) salt of 3-amino-2-cyano-3-(4-hydroxyphenyl)propanoic acid;

copper (II) salt of 3-amino-2-cyano-3-(4-hydroxy-3-methoxy phenyl)propanoic acid;

copper (II) salt of 2-methoxysuccinic acid;

copper (II) salt of 2-ethoxysuccinic acid;

copper (II) salt of 3-(2-furyl)-2-carboxypropenoic acid;

copper (II) salt of 3-(2-thiazolyl)-2-carboxypropenoic acid;

copper (II) salt of 3-benzylidene-2-carboxypropenoic acid;

copper (II) salt of diallylmalonic acid;

copper (II) salt of ethylphenylmalonic acid;

copper (II) salt of bis(2-cyano ethyl)malonic acid;

copper (II) salt of N-morpholine malonic acid;

copper (II) salt of N-benzyloxyiminomalonic acid;

The compounds having formula (I) can be easily obtained according to the reaction scheme A: 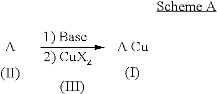
wherein A has the same meanings defined above and z has the value of 1 or 2.

The compounds having general formula (I) can be obtained by dissolving the organic carboxylic acid having general formula (II) in water using at least two equivalents of an inorganic base such as sodium or potassium bicarbonate, sodium or potassium or calcium hydroxide, and adding an aqueous solution of a copper salt having formula (III) to the resulting mixture, wherein X can be a halogen, such as chlorine or bromine, or a perchlorate, (Z=2); or a sulfate ion, (z=1) to give a compound having formula (I).

Alternatively, it is possible to use copper hydroxide or carbonate (in these cases X represents an OH group or a CO₃ group respectively and z has the value of 2 or 1 respectively) in the presence of the acid form (II), optionally in the presence of an additional base, such as for example, an organic amine such as triethylamine.

Alternatively, the compounds having general formula (I) can be obtained by the saponification of esters corresponding to the organic carboxylic acids having general formula (II), in water and alcohol according to the traditional synthesis procedures, and subsequent addition to the resulting mixture of an aqueous solution of a copper salt having formula (III) as described above.

The carboxylic acids having general formula (II), when not known in themselves, can be prepared according to methods known in literature, according to what is described, for example, in: Organic Reactions (1967), vol. 15, page 204; or in Proc. Indian Acad. Sci. (1941), vol. 14A, pages 112-122; or in J. Org. Chem. (1979), vol. 44, page 3136.

If the organic acids corresponding to general formula (II) contain optical or geometric isomerism centres, the compounds having general formula (I) can be present in all possible configurational isomeric forms.

The scope of the present invention therefore also includes the use of compounds having general formula (I) as isomeric mixtures in any proportion, as well as the production and use of the single isomers for the control of phytopathogen fungi in the agronomical field.

The compounds having general formula (I) can also be present in hydrated form by the coordination of a any number of molecules of water.

The compounds having general formula (I) can also coordinate within their structure metallic cations, such as, for example, sodium, calcium, potassium, whose number can vary in relation to the preparation method used for the synthesis of the cupric salt having general formula (I) and they can possibly be present in the hydrated form.

The use of these mixed salts for the control of phytopathogen fungi in the agronomical field, also falls within the scope of the present invention.

The copper salts of carboxylic acids having general formula (I) are capable of controlling many fungal and bacterial phytopathogens, also with a reduced sensitivity towards other fungicides.

Some examples of phytopathogens controlled by the compounds having general formula (I) alone or in a mixture, are listed below for purely illustrative and non-limiting purposes, together with examples of possible application crops:

Plasmopara viticola on vines;

Phytophthora spp. on vegetables;

Pyricularia oryzae on rice;

Venturia inaequalis on apples;

Peronospora tabacina on tobacco;

Pseudoperonospora cubensis. on cucurbitaceous products;

Bremia on salads, spinach;

Alternaria spp. on tomatoes, potatoes.

The cupric salts having general formula (I) are capable of exerting a high fungicidal action of both a curative and preventive nature and they also have a low phyto-toxicity or absence thereof.

A further object of the present invention therefore relates to a method for the control of phytopathogen fungi in agricultural crops by the application of compounds having general formula (I).

The quantity of compound to be applied for obtaining the desired effect can vary in relation to several factors, such as, for example, the compound used, the crop to be preserved, the type of pathogen, the degree of infection, the climatic conditions, the application method, the formulation adopted.

Dosages of compound ranging from 10 g to 5 kg per hectare, generally provide a sufficient control.

For practical use in agriculture, it is often convenient to adopt fungicidal compositions containing one or more of the compounds having general formula (I).

The application of these compositions or compounds having general formula (I) can be effected on any part of the plant, for example on the leaves, stems, branches and roots, or on the seeds before being planted, or on the ground in which the plant grows.

Compositions can be used which are in the form of dry powders, wettable powders, emulsifiable concentrates, micro-emulsions, pastes, granulates, solutions, suspensions, etc.: the selection of the type of composition will depend on the specific use.

The compositions are prepared according to known methods, for example by diluting or dissolving the active substance with a solvent and/or solid diluent, possibly in the presence of surfactants.

Silica, kaolin, bentonite, talc, infusorial earth, dolomite, calcium carbonate, magnesia, chalk, clays, synthetic silicates, attapulgite, seppiolite, can be used as solid diluents, or carriers.

In addition to water, aromatic organic solvents (xylols or mixtures of alkyl benzols, chlorobenzene, etc.), paraffins (oil fractions), alcohols (methanol, propanol, butanol, octanol, glycerin, etc.), esters (ethyl acetate, isobutyl acetate, etc.), ketones (cyclohexanone, acetone, acetophenone, isophorone, ethyl amyl ketone, etc.), amides (N,N-dimethyl formamide, N-methyl pyrrolidone, etc.), can be used as liquid diluents.

Sodium, calcium, triethyl amine or triethanol amine salts of alkyl sulphonates, alkyl aryl sulphonates, polyethoxylated alkyl phenols, polyoxyethylated esters of sorbitol, lignin sulfonates, etc., can be used as surfactants.

The compositions can also contain special additives for particular purposes, such as, for example, adhesion agents, such as gum Arabic, polyvinyl alcohol, polyvinyl pyrrolidone, polyacrylates.

In the above compositions, the concentration of active substances ranges from 0.1 to 98%, preferably from 0.5 to 90%.

Other compatible active principles can be added, if desired, to the compounds having general formula (I), such as, for example, fungicides, phyto-regulators, antibiotics, herbicides, insecticides, fertilizers.

Examples of other fungicides which can be included in the compositions of the invention are:

AC-382042, acibenzolar, ampropylfos, anilazine, azaconazole, azoxystrobin, benalaxyl (in its racemic form or as optically active R isomer), benclothiaz, benomyl, bitertanol, blasticidin-S, bromuconazole, bupirimate, buthiobate, captafol, captan, carbendazim, carboxin, carpropamid, chinomethionat, chloroneb, chlorothalonil, chlozolinate, cuprocalcic, cyazofamid, cymoxanil, cyproconazole, cyprodinil, debacarb, dichlofluanid, dichlone, diclobutrazol, diclomezine, dicloran, diclocymet, diethofencarb, diphenoconazole, diflumetorim, dimethirimol, dimethomorph, diniconazole, dinocap, a fungicidal dipeptide, dipyrithione, ditalimfos, dithianon, dodemorph, dodine, edifenphos, epoxiconazole, etaconazole, ethaboxam, ethirimol, ethoxyquin, etridiazole, famoxadone, fenamidone, fenaminosulf, fenapanil, fenarimol, fenbuconazole, fenfuram, fenhexamid, fenoxanil, fenpiclonil, fenpropidin, fenpropimorph, fentin, ferbam, ferimzone, fluazinam, fludioxonil, flumetover, flumorph, fluoroimide, fluotrimazole, fluoxastrobin, fluquinconazole, flusilazole, flusulfamide, flutolanil, flutriafol, folpet, fosetylaluminium, fuberidazole, furalaxyl, furconazole, guazatine, hexaconazole, hydroxyquinoline sulfate, hymexazol, ICIA0858, imazalil, imibenconazole, iminoctadine, ipconazole, iprobenfos, iprodione, isoprothiolane, iprovalicarb, kasugamycin, kresoxim-methyl, mancopper, mancozeb, maneb, mebenil, mepanipyrim, mepronil, metalaxyl, metalaxyl-M, metconazole, methfuroxam, metiram, metsulfovax, MON-65500, myclobutanil, natamycin, nicobifen, nitrothal-isopropyl, nuarimol, ofurace, orisastrobin, tetraramic oxychloride, oxadixyl, oxycarboxin, pefurazoate, penconazole, pencycuron, pentachlorophenol and its salts, penthiovalicarb, phthalide, piperalin, Bordeaux mixture, polyoxins, probenazole, prochloraz, procymidone, propamocarb, propiconazole, propineb, proquinazid, prothiocarb, prothioconazole, pycoxystrobin, pyracar-bolid, pyraclostrobin, pyrazophos, pyrifenox, pyrimethanil, pyroquilon, pyroxyfur, quinacetol, quinazamid, quinconazole, quinoxyfen, quintozene, rabenazole, copper hydroxide, copper oxychloride, copper sulfate, RH-7281, RPA-407213, simeconazole, spiroxamine, spiromesifen, SSF-126, (metominostrobin), streptomycin, SYP-L-190, tebuconazole, tetraconazole, thiabendazole, thicyofen, thifluzamide, thiophanate-methyl, thiram, tioxymid, tolclofos-methyl, tolylfluanid, triadimefon, triadimenol, triarimol, triazbutil, triazoxide, tricyclazole, tridemorf, trifloxystrobin (CGA 279202), triflumizole, triforine, triticonazole, validamycin, vinclozolin, zineb, ziram, sulfur, zoxamide.

These fungicidal compounds are commercial products or products about to be commercialized. Their description can be easily found in technical literature, for example in “The pesticide manual”, 2000, XII Edition, British Crop Protection Council Ed.

Dipeptide with a fungicidal activity refers to one of the compounds among those claimed in patent application EP-A-1028125.

It has also been found that the salts of derivatives of carboxylic acids having general formula (I), also exert a synergic action with many of the active principles listed above, thus representing an excellent instrument for anti-resistance strategies and allowing a further lowering in the applicative dosages.

The following examples are provided for illustrative purposes, for a better understanding of the invention, and should in no way be considered as limiting the scope of the present invention.

### EXAMPLE 1

### Preparation of the Copper Salt of 4-chlorobenzylidene Malonic Acid (Compound Nr. 1)

8 g of 4-chlorobenzylidenemalonic acid are added to a solution of 5.95 g of sodium bicarbonate in 140 cm³ of water. After the complete dissolution of the acid, a solution of 8.74 g of copper sulfate in 20 cm³ of water, are added to the reaction mixture. The mixture is kept under stirring at room temperature for a night. The solid precipitated is filtered and washed with water, obtaining, after drying in the air, 8.85 g of compound Nr. 1 (yield: 88%).

Elemental analysis [% found (theoretical)]=C 41.1 (41.7); H 1.9 (1.7); Cl 12.3 (12.7); Cu 21.9 (22.1).

### EXAMPLE 2

### Preparation of the Copper Salt of 4-hydroxy-3-methoxybenzylidene Malonic Acid Monomethyl Ester (Compound Nr. 50).

17.8 cm³ of a 3.1 N solution of NaOH are slowly added dropwise on an ice bath to a suspension of 7.4 g of 4-hydroxy-3-methoxybenzylidene malonic acid dimethyl ester in 8 cm³ of methanol. The resulting solution is left under stirring for 24 hours at room temperature; a solution of copper sulfate (6.95 g in 16 cm³ of H₂O) is then added and the mixture is kept under stirring for a further 24 hours. The solid precipitated is filtered and washed with water, obtaining, after drying in the air, 7.0 g of compound Nr. 47 (yield: 81%).

Elemental analysis [% found (theoretical)]=C 45.2 (45.9); H 3.1 (3.2); Cu 20.4 (20.2).

### EXAMPLE 3

### Preparation of the Copper Salt of 3-ketoglutaric Acid (Compound Nr. 132).

11.5 g of sodium bicarbonate are added in portions, on an ice bath, to a suspension of 10 g of 3-ketoglutaric acid in 45 cm³ of H₂O. 9.1 g of copper (II) chloride are then added, again on an ice bath. The reaction mixture is left under stirring for 24 hours at room temperature. The solid precipitated is filtered and washed with water, obtaining, after drying in the air, 12.0 g of compound Nr. 129 (yield 83%).

Elemental analysis [% found (theoretical)]=C 28.2 (28.9); H 2.0 (1.9); Cu 30.7 (30.6).

### EXAMPLE 4

### Preparation of the Copper Salt of 2-methoxysuccinic Acid (Compound Nr. 239).

10 g of dimethyl maleate are added under stirring to 25 cm³ of a 3 M methanol solution of MeONa. After an hour, 10 cm³ of a 7 N solution of NaOH are added dropwise and after another hour a solution of copper sulfate (17.2 g in 45 cm³ of H₂O) is added. The reaction mixture is kept under stirring for a further 24 hours. The solid precipitated is filtered and washed with water, obtaining, after drying in the air, 11.2 g of compound Nr. 235 (yield 80%).

Elemental analysis [% found (theoretical)]=C 28.3 (28.6); H 2.7 (2.9); Cu 29.9 (30.3).

### EXAMPLE 5

### Preparation of the Copper Salt of 5-chlorosalicylic Acid (Compound Nr. 275).

10 cm³ of a 5.8 N solution of NaOH are added to a suspension of 5 g of 5-chlorosalicylic acid in 10 cm³ of H₂O. After the complete dissolution of the acid, a solution of copper chloride (3.9 g in 40 cm³ of H₂O) is added. The reaction mixture is kept under stirring for 24 hours. The solid precipitated is filtered and washed with water, obtaining, after drying in the air, 6.3 g of compound Nr. 269 (yield 93%).

Elemental analysis [% found (theoretical)]=C 35.4 (35.9); H 1.25 (1.3); Cl 15.1 (14.9); Cu 26.9 (27.1).

Analogously to what is described in the examples, the following compounds were prepared:

TABLE 1
Derivatives of general formula (I) wherein A has the
meaning of (A₁):

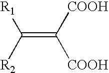

| Compound Nr. | R₁ | R₂ |
|---|---|---|
| 2 | 4-OH-3-OCH₃-phenyl | H |
| 3 | 3,4-di-OCH₃-phenyl | H |
| 4 | 4-F-phenyl | H |
| 5 | 4-CF₃-phenyl | H |
| 6 | 4-CH₃-phenyl | H |
| 7 | 4-OCH₃-phenyl | H |
| 8 | 2,4-diCl-phenyl | H |
| 9 | 4-Br-phenyl | H |
| 10 | 2-OH-phenyl | H |
| 11 | 2,6-diCl-phenyl | H |
| 12 | 4-OH-phenyl | H |
| 13 | 4-CH₃-phenyl | H |
| 14 | 2-CF₃-phenyl | H |
| 15 | 4-OH-3-OCH₃-phenyl | CH₃ |
| 16 | 3-4-diOCH₃-phenyl | CH₃ |
| 17 | 4-Cl-phenyl | CF₃ |
| 18 | 4-CF₃-phenyl | CH₂CH₃ |
| 19 | 4-OH-3-OCH₃-phenyl | phenyl |
| 20 | 3,4-diOCH₃-phenyl | phenyl |
| 21 | 4-Cl-phenyl | phenyl |
| 22 | 4-OH-3-OCH₃-phenyl | cyclopentyl |
| 23 | 3,4-diOCH₃-phenyl | cyclopropyl |
| 24 | 4-OCF₃-phenyl | H |
| 25 | 1-naphthyl | H |
| 26 | 4-N(CH₃)₂phenyl | H |
| 27 | Cyclopentyl | H |
| 28 | Cyclohexyl | H |
| 29 | 3,4-methylenedioxyphenyl | H |
| 30 | CH₃ | CH₃ |
| 31 | Isopropyl | H |
| 32 | Benzyl | H |
| 33 | CF₃ | H |
| 34 | Isobutyl | CH₃ |
| 35 | 2-(phenyl)ethyl | H |
| 36 | 1-(phenyl)ethyl | H |
| 37 | 2-furyl | H |
| 38 | 2-thiazolyl | H |
| 39 | 2-furyl | CH₃ |
| 40 | 2-thiazolyl | CH₃ |
| 41 | 2-pyridyl | H |
| 42 | 2-pyridyl | CH₃ |
| 43 | 4-pyridyl | CH₃ |
| 44 | 4-pyridyl | H |
| 45 | 2-pyrimidyl | H |
| 46 | benzylidene | H |
| 47 | 2-Cl-phenyl | H |
| 48 | ethoxyl | H |
| 49 | phenyl | H |

TABLE 2
Derivatives of general formula (I) wherein A has the
meaning of (A₂):

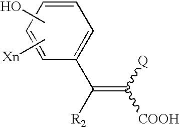

| Comp. Nr. | OH pos. | X | n | R₂ | Q |
|---|---|---|---|---|---|
| 51 | 4 | 3-OCH₃ | 1 | H | CN |
| 52 | 4 | 3-OCH₃ | 1 | H | H |
| 53 | 4 | 3-OCH₃ | 1 | H | COCH₃ |
| 54 | 4 | 3-OCH₃ | 1 | H | CONH₂ |
| 55 | 4 | 3-OCH₃ | 1 | CH₃ | COOCH₃ |
| 56 | 4 | 3-OCH₃ | 1 | H | COOCH₂CH₃ |
| 57 | 4 | 3-OCH₃ | 1 | H | COOCH(CH₃)₂ |
| 58 | 4 | 3-OCH₃ | 1 | H | CONHCH₃ |
| 59 | 4 | 3-OCH₃ | 1 | H | CON(CH₃)₂ |
| 60 | 4 | 3-OCH₃ | 1 | H | CH₂CH₃ |
| 61 | 4 | 3-OCH₃ | 1 | H | CH₃ |
| 62 | 4 | 3-OCH₃ | 1 | H | CF₃ |
| 63 | 4 | 3-OCH₃ | 1 | H | COOCH₂Ph |
| 64 | 4 | 3-OCH₃ | 1 | H | COCF₃ |
| 65 | 4 | 3-OCH₃ | 1 | Ph | COCF₃ |
| 66 | 4 | 3,5-diOCH₃ | 2 | H | COOCH₃ |
| 67 | 4 | 3,5-diOCH₃ | 2 | H | H |
| 68 | 4 | 3,5-diOCH₃ | 2 | H | COCH₃ |
| 69 | 4 | 3,5-diOCH₃ | 2 | H | CONH₂ |
| 70 | 4 | 3,5-diOCH₃ | 2 | H | CN |
| 71 | 4 | 3,5-diCl | 2 | H | COOCH₃ |
| 72 | 4 | 3,5-diCl | 2 | H | H |
| 73 | 4 | 3,5-diCl | 2 | H | COCH₃ |
| 74 | 4 | 3,5-diCl | 2 | H | CONH₂ |
| 75 | 4 | 3.5-diCl | 2 | H | CN |
| 76 | 4 | 3,5-diBr | 2 | H | COOCH₃ |
| 77 | 4 | 3,5-diBr | 2 | H | H |
| 78 | 4 | 3,5-diBr | 2 | H | COCH₃ |
| 79 | 4 | 3,5-diBr | 2 | H | CONH₂ |
| 80 | 4 | 3,5-diBr | 2 | H | CN |
| 81 | 2 | 5-Cl | 1 | H | COOCH₃ |
| 82 | 2 | 5-Cl | 1 | H | CN |
| 83 | 2 | 5-Cl | 1 | H | H |
| 84 | 2 | 5-Cl | 1 | H | COCH₃ |
| 85 | 2 | 5-Cl | 1 | H | CONH₂ |
| 86 | 2 | 5-Cl | 1 | H | COOCH₂CH₃ |
| 87 | 2 | 5-Cl | 1 | H | CONHCH₃ |
| 88 | 2 | 5-Cl | 1 | H | CON(CH₃)₂ |
| 89 | 2 | 5-Cl | 1 | H | CH₂CH₃ |
| 90 | 2 | 5-Cl | 1 | H | CH₃ |
| 91 | 2 | 3-CH₃ | 1 | H | COOCH₃ |
| 92 | 2 | 3-CH₃ | 1 | CH₃ | COOCH₃ |
| 93 | 2 | 3-CH₃ | 1 | Ph | COOCH₃ |
| 94 | 2 | 3-CH₃ | 1 | H | COOCH₂CH₃ |
| 95 | 2 | 3-CH₃ | 1 | H | COCF₃ |
| 96 | 2 | 3-CH₃ | 1 | H | CONHCH₃ |
| 97 | 2 | 3-CH₃ | 1 | CH₃ | COOCH₂Ph |
| 98 | 2 | 3-CH₃ | 1 | H | COOCH₂Ph |
| 99 | 2 | 5-Br | 1 | H | COCF₃ |
| 100 | 2 | 5-Br | 1 | H | CON(CH₃)₂ |
| 101 | 2 | 5-Br | 1 | H | H |
| 102 | 2 | H | 1 | H | COOCH₃ |
| 103 | 2 | H | 1 | H | CN |
| 104 | 2 | H | 1 | CH₃ | CN |
| 105 | 2 | H | 1 | H | COCH₃ |
| 106 | 2 | H | 1 | H | CONH₂ |
| 107 | 2 | H | 1 | H | H |
| 108 | 2 | H | 1 | H | COCF₃ |
| 109 | 2 | H | 1 | H | CONHCH₃ |
| 110 | 2 | H | 1 | H | COOCH₂Ph |
| 111 | 2 | H | 1 | H | COOCH(CH₃)₂ |
| 112 | 3 | H | 1 | H | H |
| 113 | 3 | H | 1 | H | COOCH₃ |
| 114 | 3 | H | 1 | H | CN |
| 115 | 3 | H | 1 | H | COCH₃ |
| 116 | 3 | H | 1 | H | CONH₂ |
| 117 | 4 | H | 1 | H | H |
| 118 | 4 | H | 1 | H | COOCH₃ |
| 119 | 4 | H | 1 | H | CN |
| 120 | 4 | H | 1 | H | COCH₃ |
| 121 | 4 | H | 1 | H | CONH₂ |
| 122 | 4 | H | 1 | H | COOCH₂CH₃ |
| 123 | 4 | H | 1 | 4-OHPh | COOCH₂CH₃ |
| 124 | 4 | H | 1 | H | CONHCH₃ |
| 125 | 4 | H | 1 | H | CON(CH₃)₂ |
| 126 | 4 | H | 1 | H | CH₂CH₃ |
| 127 | 4 | H | 1 | H | CH₃ |
| 128 | 4 | H | 1 | H | CF₃ |
| 129 | 4 | H | 1 | H | COCF₃ |
| 130 | 4 | H | 1 | CH₃ | COOCH₃ |
| 131 | 4 | H | 1 | CH₃ | CN |

TABLE 3
Derivatives of general formula (I) wherein A has the
meaning of (A₃):

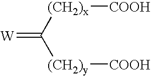

| Comp. Nr. | W | x | y |
|---|---|---|---|
| 133 | O | 0 | 0 |
| 134 | CH₃ON | 1 | 1 |
| 135 | CH₃ON | 0 | 0 |
| 136 | CH₃N | 0 | 0 |
| 137 | CH₃N | 0 | 1 |
| 138 | O | 1 | 0 |
| 139 | CH₃N | 1 | 1 |
| 140 | EtN | 1 | 1 |
| 141 | PhCH₂N | 1 | 1 |
| 142 | PhN | 1 | 1 |
| 143 | 4-ClPhN | 1 | 1 |
| 144 | PhN | 0 | 0 |
| 145 | 2-pyridylN | 1 | 1 |
| 146 | 4-pyridylN | 1 | 1 |
| 147 | PhON | 1 | 1 |
| 148 | PhON | 0 | 0 |
| 149 | BzON | 0 | 0 |
| 150 | CH₃N | 1 | 2 |
| 151 | PhON | 1 | 2 |
| 152 | CH₃ON | 1 | 2 |
| 153 | 4-ClPhON | 1 | 1 |
| 154 | 4-OCH₃PhON | 1 | 1 |
| 155 | 4-OCH₃PhN | 1 | 1 |
| 156 | 4-CH₃PhN | 1 | 1 |

TABLE 4
Derivatives of general formula (I) wherein A has the
meaning of (A₄):

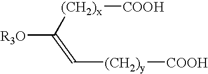

| Comp. Nr. | R₃ | x | y |
|---|---|---|---|
| 157 | CH₃ | 1 | 0 |
| 158 | CH₃ | 1 | 1 |
| 159 | Ethyl | 1 | 1 |
| 160 | Benzyl | 1 | 1 |
| 161 | CH₃ | 2 | 1 |
| 162 | i-propyl | 1 | 0 |
| 163 | Benzyl | 2 | 1 |
| 164 | CH₃ | 0 | 0 |
| 165 | Ethyl | 0 | 0 |

TABLE 5
Derivatives of general formula (I) wherein A has the
meaning of (A₅):

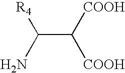

| Compound Nr. | R₄ |
|---|---|
| 166 | 4-Cl-phenyl |
| 167 | 4-OH-3-OCH₃-phenyl |
| 168 | 3,4-diOCH₃-phenyl |
| 169 | 4-CF₃-phenyl |
| 170 | 4-CH₃-phenyl |
| 171 | 4-OCH₃-phenyl |
| 172 | 2,4-diCl-phenyl |
| 173 | 4-Br-phenyl |
| 174 | 2-OH-phenyl |
| 175 | 2,6-diCl-phenyl |
| 176 | 4-OCF₃-phenyl |
| 177 | 2-CF₃-phenyl |
| 178 | 2-pyridyl |
| 179 | 4-pyridyl |
| 180 | 2-furyl |
| 181 | 2-thiazolyl |
| 182 | 2-pyrimidyl |
| 183 | isopropyl |
| 184 | isobutyl |
| 185 | CF₃ |
| 186 | Cyclopentyl |
| 187 | Cyclopropyl |
| 188 | Cyclohexyl |
| 189 | CH₃ |
| 190 | Benzyl |
| 191 | 2-(phenyl)ethyl |
| 192 | 1-(phenyl)ethyl |
| 193 | t-butyl |
| 194 | 4-F-phenyl |

TABLE 6
Derivatives of general formula (I) wherein A has the
meaning of (A₆):

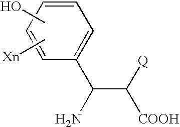

| Comp. Nr. | OH pos. | X | n | Q |
|---|---|---|---|---|
| 195 | 4 | 3-OCH₃ | 1 | CN |
| 196 | 4 | 3,5-diOCH₃ | 2 | CN |
| 197 | 4 | 3-OCH₃ | 1 | H |
| 198 | 4 | 3,5-diOCH₃ | 2 | H |
| 199 | 4 | 3-OCH₃ | 1 | COCH₃ |
| 200 | 4 | 3-OCH₃ | 1 | COCF₃ |
| 201 | 4 | 3-OCH₃ | 1 | CONH₂ |
| 202 | 4 | 3-OCH₃ | 1 | COOCH₂CH₃ |
| 203 | 4 | 3-OCH₃ | 1 | COOCH(CH₃)₂ |
| 204 | 4 | 3-OCH₃ | 1 | CONHCH₃ |
| 205 | 4 | 3-OCH₃ | 1 | CON(CH₃)₂ |
| 206 | 4 | 3-OCH₃ | 1 | CH₂CH₃ |
| 207 | 4 | 3-OCH₃ | 1 | CH₃ |
| 208 | 4 | 3-OCH₃ | 1 | CF₃ |
| 209 | 4 | 3-OCH₃ | 1 | COOCH₂Ph |
| 210 | 4 | H | 1 | CN |
| 211 | 4 | H | 1 | COOCH₂CH₃ |
| 212 | 4 | H | 1 | COOCH(CH₃)₂ |
| 213 | 4 | H | 1 | CONHCH₃ |
| 214 | 4 | H | 1 | CON(CH₃)₂ |
| 215 | 4 | H | 1 | CH₂CH₃ |
| 216 | 4 | H | 1 | CH₃ |
| 217 | 4 | H | 1 | CF₃ |
| 218 | 4 | H | 1 | COOCH₂Ph |
| 219 | 4 | H | 1 | COCF₃ |
| 220 | 2 | 5-Cl | 1 | CN |
| 221 | 4 | 3,5-Cl | 2 | CN |
| 222 | 2 | 5-Cl | 1 | H |
| 223 | 4 | 3,5-Cl | 2 | H |
| 224 | 2 | 5-Cl | 1 | COCH₃ |
| 225 | 2 | 5-Cl | 1 | CONH₂ |
| 226 | 2 | 5-Cl | 1 | COCF₃ |
| 227 | 2 | 5-Cl | 1 | COOCH₂CH₃ |
| 228 | 2 | 5-Cl | 1 | COOCH(CH₃)₂ |
| 229 | 2 | 5-Cl | 1 | CONHCH₃ |
| 230 | 2 | 5-Cl | 1 | CON(CH₃)₂ |
| 231 | 2 | 5-Cl | 1 | CH₂CH₃ |
| 232 | 2 | 5-Cl | 1 | CH₃ |
| 233 | 2 | 5-Cl | 1 | CF₃ |
| 234 | 2 | 3-CH₃ | 1 | CN |
| 235 | 2 | 3-CH₃ | 1 | CONHCH₃ |
| 236 | 2 | 3-CH₃ | 1 | CON(CH₃)₂ |
| 237 | 2 | 5-Br | 1 | H |
| 238 | 2 | H | 1 | H |

TABLE 7
Derivatives of general formula (I) wherein A has the
meaning of (A₇):

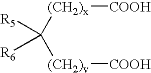

| Comp. Nr. | R₅ | R₆ | x | y |
|---|---|---|---|---|
| 240 | EtO | H | 0 | 1 |
| 241 | IPrO | H | 0 | 1 |
| 242 | Allyl | Allyl | 0 | 0 |
| 243 | 2-cyanoethyl | 2-cyanoethyl | 0 | 0 |
| 244 | N-morpholine | H | 0 | 0 |
| 245 | Ethyl | Phenyl | 0 | 0 |
| 246 | Methyl | 3-OCH₃-phenyl | 0 | 0 |
| 247 | Ethyl | isoamyl | 0 | 0 |
| 248 | Butyl | Butyl | 0 | 0 |
| 249 | Cyclopropyl | H | 0 | 0 |
| 250 | Cyclopentyl | H | 0 | 0 |
| 251 | 4-OH-propyl | 4-OH-propyl | 0 | 0 |
| 252 | CF₃ | Ethyl | 0 | 0 |
| 253 | CH₃ | 2-pyridyl | 0 | 0 |
| 254 | Hexyl | H | 0 | 0 |
| 255 | Phenyl | H | 0 | 0 |
| 256 | Allyl | H | 0 | 0 |
| 257 | N-propyl | N-propyl | 0 | 0 |
| 258 | iso-propyl | H | 0 | 0 |
| 259 | Benzyl | H | 0 | 0 |
| 260 | Butyl | H | 0 | 0 |
| 261 | Ethyl | H | 0 | 0 |
| 262 | 3-thienyl | H | 0 | 0 |
| 263 | N,N-dibutyl | H | 0 | 0 |
| 264 | t-butyl | H | 1 | 2 |
| 265 | CH₃ | H | 1 | 2 |
| 266 | N,N-diethyl | H | 0 | 3 |
| 267 | PhCONH | H | 0 | 0 |
| 268 | CH₃CONH | H | 0 | 0 |
| 269 | 4-CH₃PhCO | H | 0 | 0 |
| 270 | 2,6-dimethylmorpholine | H | 0 | 0 |
| 271 | HOCH₂ | HOCH₂ | 0 | 0 |
| 272 | (CH₃)₂N | H | 0 | 0 |

| | | | |
|---|---|---|---|
| 273 | —CH₂CH₂— | 0 | 0 |
| 274 | —CH₂CH₂CH₂— | 0 | 0 |

TABLE 8
Derivatives of general formula (I) wherein A has the
meaning of (A₈):

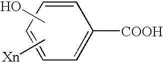

| Comp. Nr. | OH pos. | X | n |
|---|---|---|---|
| 276 | 3 | H | 1 |
| 277 | 4 | H | 1 |
| 278 | 2 | 3-OH | 1 |
| 279 | 2 | 6-OH | 1 |
| 280 | 3 | 4-OH | 1 |
| 281 | 2 | 3-OCH₃ | 1 |
| 282 | 2 | 5-OCH₃ | 1 |
| 283 | 2 | 5-Br | 1 |
| 284 | 2 | 3-CH₃ | 1 |
| 285 | 2 | 5-F | 1 |
| 286 | 2 | 5-CN | 1 |
| 287 | 2 | 5-CF₃ | 1 |
| 288 | 2 | 3-NH₂ | 1 |
| 289 | 2 | 3-N(CH₃)₂ | 1 |
| 290 | 4 | 3,5-diCl | 2 |
| 291 | 4 | 3,5-diBr | 2 |
| 292 | 4 | 3,5-diOCH₃ | 2 |
| 293 | 4 | 3,5-diCH₃ | 2 |
| 294 | 4 | 3-OCH₃ | 1 |
| 295 | 4 | 3-Cl | 1 |
| 296 | 4 | 3-NO₂ | 1 |

### EXAMPLE 6

### Determination of the Fungicidal Activity Against Peronospora in Vines (Plasmopara viticola).

Vine plant leaves (cultivar Dolcetto) grown in vases in a conditioned environment (20±1° C., 70% relative humidity) are treated by spraying both sides of the leaf with compounds 1, 2 and 3, dispersed in a hydro-acetone solution at 20% by volume in acetone.

After remaining 24 hours in a conditioned atmosphere, the plants are sprayed on both sides of the leaf with an aqueous suspension of conidia of Plasmopara viticola (20000 conidia per cm³).

The plants are kept in a humidity saturated environment at 21° C. for the incubation period of the fungus.

At the end of said period (7 days), the fungicidal activity is evaluated according to a percentage evaluation scale from 0 (completely infected plant) to 100 (healthy plant).

All the compounds tested showed a fungus control higher than 90 at a concentration of 1000 ppm.

1. Use of compounds having general formula (I):
A·Cu (I)
wherein:
A represents the bibasic ion of an organic acid which can have the meanings (A₁)-(A₈);
Cu represents the copper 2+ion;
(A₁)-(A₈) respectively represent the following carboxylic acids: 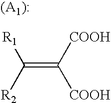
wherein:
R₁ and R₂, the same or different, represent a hydrogen atom; a C₁-C₆ alkyl or C₁-C₆ haloalkyl group, linear or branched, optionally substituted; a C₂-C₆ alkenyl or C₂-C₆ haloalkenyl group, linear or branched, optionally substituted; a C₃-C₆ cycloalkyl group, optionally substituted; a C₁-C₆ alkoxyl or C₁-C₆ haloalkoxyl group, linear or branched, optionally substituted; a C₁-C₆ alkylthio or C₁-C₆ haloalkylthio group, linear or branched, optionally substituted; a C₃-C₆ cycloalkoxyl group, optionally substituted; an aryl group optionally substituted or a heteroaryl group optionally substituted; a heterocyclic group optionally substituted; 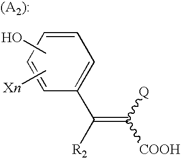
wherein:
R₂ has the meanings defined above;
Q represents a hydrogen atom; a C₁-C₆ alkyl or C₁-C₆ haloalkyl group, linear or branched, optionally substituted; a cyano group; a C₁-C₆ alkylcarbonyl or C₁-C₆ haloalkylcarbonyl group, linear or branched, optionally substituted; a C₁-C₆ alkoxycarbonyl, linear or branched, optionally substituted; an aminocarbonyl group; a C₁-C₆ alkylaminocarbonyl group; a C₂-C₁₂ dialkylaminocarbonyl group;
X represents a hydrogen atom or a halogen atom; a hydroxyl group; a C₁-C₆ alkyl or C₁-C₆ haloalkyl group, linear or branched, optionally substituted; a C₁-C₆ alkoxyl or C₁-C₆ haloalkoxyl group, linear or branched, optionally substituted; a cyano group; a nitro group; an amine group; a C₁-C₆ alkylamine group; a C₂-C₁₂ dialkylamine group; a C₁-C₆ linear or branched thioalkyl group, possibly substituted; a C₁-C₆ linear or branched halothioalkyl group, possibly substituted; a C₁-C₆ linear or branched alkylsulfinyl group, possibly substituted; a C₁-C₆ linear or branched alkylsulfonyl group, possibly substituted;
n is a number ranging from 1 to 4; 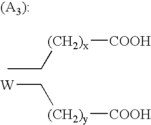
wherein:
W represents an oxygen atom; a C₁-C₆ alkylimine group, linear or branched, optionally substituted; an arylimine group optionally substituted; a hetero-aryl imine group optionally substituted; a C₁-C₆ alkoxyimine group, linear or branched, optionally substituted; an aryloxyimine group optionally substituted;
x and y, the same or different, are a number ranging from 0 to 4; 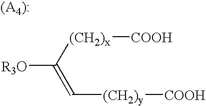
wherein:
R₃ represents a C₁-C₆ alkyl or C₁-C₆ haloalkyl group, linear or branched, optionally substituted; a C₃-C₆ cycloalkyl group, optionally substituted; an aryl group, optionally substituted; a heteroaryl group, optionally substituted;
x and y, the same or different, are a number ranging from 0 to 4; 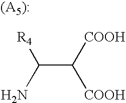
wherein:
R₄ represents a C₁-C₆ alkyl or C₁-C₆ haloalkyl group, linear or branched, optionally substituted; a C₃-C₆ cycloalkyl group, optionally substituted; an aryl group, optionally substituted; a heteroaryl group, optionally substituted; 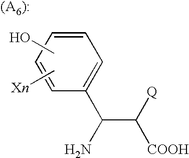
wherein:
Q, X and n have the same meanings defined above; 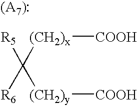
wherein:
R₅ and R₆, the same or different, represent a hydrogen atom; a halogen atom; a C₁-C₆ alkyl or C₁-C₆ haloalkyl group, linear or branched, optionally substituted; a C₂-C₆ alkenyl or C₂-C₆ haloalkenyl group, linear or branched, optionally substituted; a C₂-C₆ alkinyl or C₂-C₆ haloalkinyl group, linear or branched, optionally substituted; a C₃-C₆ cycloalkyl group, optionally substituted; a C₁-C₆ alkoxyl or C₁-C₆ haloalkoxyl group, linear or branched, optionally substituted; a C₁-C₆ alkylthio or C₁-C₆ haloalkylthio group, linear or branched, optionally substituted; a C₃-C₆ cycloalkoxyl group, optionally substituted; a C₁-C₆ alkylamine group, linear or branched, optionally substituted; a C₂-C₁₂ dialkylamine group, linear or branched, optionally substituted; a C₁-C₆ alkylcarbonylamine group, linear or branched, optionally substituted; an arylcarbonylamine group, optionally substituted; an aryl group, optionally substituted; a hetero-aryl group, optionally substituted; a heterocyclic group, optionally substituted;
R₅ and R₆ can jointly form a C₁-C₆ cycle;
x and y, the same or different, are a number ranging from 0 to 4 excluding cases wherein x and y are a number ranging from 0 to 2 and R₅ and R₆ are both a hydrogen atom; 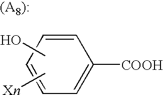
wherein
X and n have the same meanings described above excluding salicylic acid;
alone or in a mixture, for the control of bacterial and fungal phytopathogens on vegetables or parts thereof.

2. The use according to claim 1, characterized in that the compounds having general formula (I) are isomeric mixtures in any proportion or single isomers.

3. The use according to claim 1, characterized in that the compounds having general formula (I) are present in hydrated form by the coordination of any number of water molecules.

4. The use according to claim 1, characterized in that the compounds having general formula (I) coordinate further metal cations inside their structure.

5. The use according to claim 1, characterized in that the compounds having general formula (I) are in the form of mixed salts.

6. The use according to claim 1, characterized in that the compounds having general formula (I) are selected from:
copper (II) salt of 4-chlorobenzylidenemalonic acid;
copper (II) salt of 4-hydroxy-3-methoxybenzylidene malonic acid;
copper (II) salt of 3,4-dimethoxybenzylidene malonic acid;
copper (II) salt of 4-fluorobenzylidenemalonic acid;
copper (II) salt of 4-trifluoromethylbenzylidene malonic acid;
copper (II) salt of 4-dimethylaminobenzylidene malonic acid;
copper (II) salt of 2,4-dichlorobenzylidene malonic acid;
copper (II) salt of 4-bromobenzylidene malonic acid;
copper (II) salt of 4-hydroxy-3-methoxybenzylidene malonic acid monomethyl ester;
copper (II) salt of 4-hydroxy-3-methoxybenzylidene malonic acid monoethyl ester;
copper (II) salt of 2-cyano-3-(4-hydroxy-3-methoxyphenyl)propenoic acid;
copper (II) salt of 2-acetyl-3-(4-hydroxy-3-methoxyphenyl)propenoic acid;
copper (II) salt of 2-aminocarbonyl-3-(4-hydroxy-3-methoxyphenyl)propenoic acid;
copper (II) salt of 3-(4-hydroxy-3-methoxyphenyl)-2-methoxycarbonyl-2-butenoic acid;
copper (II) salt of 4-hydroxy-3-methoxycinnamic acid;
copper (II) salt of 2-hydroxycinnamic acid;
copper (II) salt of 3-hydroxycinnamic acid;
copper (II) salt of 4-hydroxycinnamic acid;
copper (II) salt of 3-ketoglutaric acid;
copper (II) salt of 3-methoxy-2-pentendioic acid;
copper (II) salt of 3-amino-2-carboxy-3-(4-chloro-phenyl)propanoic acid;
copper (II) salt of 3-amino-2-carboxy-3-(2-hydroxy-phenyl)propanoic acid;
copper (II) salt of 3-amino-2-carboxy-3-(4-trifluoromethylphenyl)propanoic acid;
copper (II) salt of 3-amino-2-carboxy-3-(4-hydroxy-3-methoxyphenyl)propanoic acid;
copper (II) salt of 3-amino-2-carboxy-3-(3,4-dimethoxyphenyl)propanoic acid;
copper (II) salt of 3-amino-3-(2-hydroxyphenyl)propanoic acid;
copper (II) salt of 3-amino-3-(4-hydroxy-3-methoxyphenyl)propanoic acid;
copper (II) salt of 3-amino-2-cyano-3-(4-hydroxyphenyl)propanoic acid;
copper (II) salt of 3-amino-2-cyano-3-(4-hydroxy-3-methoxyphenyl)propanoic acid;
copper (II) salt of 2-methoxysuccinic acid;
copper (II) salt of 2-ethoxysuccinic acid;
copper (II) salt of 3-(2-furyl)-2-carboxypropenoic acid;
copper (II) salt of 3-(2-thiazolyl)-2-carboxypropenoic acid;
copper (II) salt of 3-benzylidene-2-carboxypropenoic acid;
copper (II) salt of 1,1-cyclopropane dicarboxylic acid;
copper (II) salt of diallylmalonic acid;
copper (II) salt of ethylphenyl malonic acid;
copper (II) salt of bis(2-cyanoethyl)malonic acid;
copper (II) salt of N-morpholinemalonic acid;
copper (II) salt of N-benzyloxyiminomalonic acid;
copper (II) salt of 3-hydroxybenzoic acid;
copper (II) salt of 4-hydroxybenzoic acid;
copper (II) salt of 5-chloro-2-hydroxybenzoic acid;
copper (II) salt of 5-bromo-2-hydroxybenzoic acid;
copper (II) salt of 2-hydroxy-3-methoxybenzoic acid;
copper (II) salt of 2-hydroxy-5-methoxybenzoic acid;
copper (II) salt of 2-hydroxy-3-methylbenzoic acid;
copper (II) salt of 4-hydroxy-3-methoxybenzoic acid;
copper (II) salt of 3,5-dimethoxy-4-hydroxybenzoic acid;
copper (II) salt of 3,5-dichloro-4-hydroxybenzoic acid;
copper (II) salt of 3,5-dibromo-4-hydroxybenzoic acid;
copper (II) salt of 3,5-dimethyl-4-hydroxybenzoic acid;
copper (II) salt of 3-chloro-4-hydroxybenzoic acid;
copper (II) salt of 2,3-dihydroxybenzoic acid;
copper (II) salt of 2,6-dihydroxybenzoic acid;
copper (II) salt of 3,4-dihydroxybenzoic acid.

7. Compounds having general formula (I′):
A′·Cu (I′)
wherein:
A′ represents the bibasic ion of an organic acid which can have the meanings (A′₁)-(A′₇);
Cu represents the copper 2+ ion;
(A′₁)-(A′₇) respectively represent the following carboxylic acids: 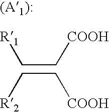
wherein:
R′₁ represents an aryl group optionally substituted;
R′₂ represents a hydrogen atom; 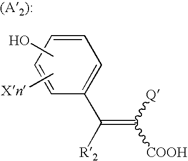
wherein:
X′ represents a hydrogen or halogen atom; a hydroxyl group; a C₁-C₆ alkoxyl group, linear or branched, optionally substituted;
n′ can have the value of 1 or 2;
R′₂ represents a hydrogen atom;
Q′ represents a hydrogen atom; a C₁-C₆ alkoxy carbonyl group, linear or branched, optionally substituted; an acetyl group; a cyano group; 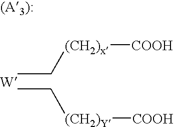
wherein:
W′ represents an oxygen atom;
x′ and y′ both have the value of 1; 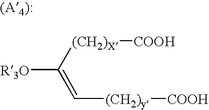
wherein:
R′₃ represents a C₁-C₃ alkyl group, linear or branched;
x′ is equal to 1 and y′ is equal to 0; 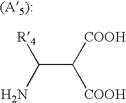
wherein:
R′₄ represents an aryl group, optionally substituted; 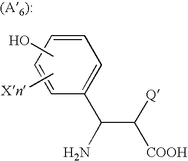
wherein:
x′ represents a hydrogen or halogen atom; a hydroxyl group; a C₁-C₆ alkoxyl group, linear or branched, optionally substituted;
n′ can have the value of 1 or 2;
Q′ represents a hydrogen atom; a C₁-C₆ alkoxy carbonyl group, linear or branched, optionally substituted; an acetyl group; a cyano group; 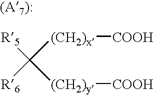
wherein:
R′₅ represents a C₁-C₆ alkoxyl group, linear or branched;
R′₆ represents a hydrogen atom;
x′ is equal to 0 and y′ is equal to 1.

8. The compounds according to claim 7, characterized in that they are selected from:
copper (II) salt of 4-chlorobenzylidenemalonic acid;
copper (II) salt of 4-hydroxy-3-methoxybenzylidene malonic acid;
copper (II) salt of 3,4-dimethoxybenzylidene malonic acid;
copper (II) salt of 4-fluorobenzylidene malonic acid;
copper (II) salt of 4-trifluoromethylbenzylidene malonic acid;
copper (II) salt of 4-dimethylaminobenzylidene malonic acid;
copper (II) salt of 2,4-dichlorobenzylidene malonic acid;
copper (II) salt of 4-bromobenzylidene malonic acid;
copper (II) salt of 4-hydroxy-3-methoxybenzylidene malonic acid monomethyl ester;
copper (II) salt of 4-hydroxy-3-methoxybenzylidene malonic acid monoethyl ester;
copper (II) salt of 2-cyano-3-(4-hydroxy-3-methoxyphenyl)propenoic acid;
copper (II) salt of 2-acetyl-3-(4-hydroxy-3-methoxyphenyl)propenoic acid;
copper (II) salt of 2-aminocarbonyl-3-(4-hydroxy-3-methoxyphenyl)propenoic acid;
copper (II) salt of 3-(4-hydroxy-3-methoxyphenyl)-2-methoxycarbonyl-2-butenoic acid;
copper (II) salt of 4-hydroxy-3-methoxycinnamic acid;
copper (II) salt of 2-hydroxycinnamic acid;
copper (II) salt of 3-hydroxycinnamic acid;
copper (II) salt of 4-hydroxycinnamic acid;
copper (II) salt of 3-ketoglutaric acid;
copper (II) salt of 3-methoxy-2-pentendioic acid;
copper (II) salt of 3-amino-2-carboxy-3-(4-chloro-phenyl)propanoic acid;
copper (II) salt of 3-amino-2-carboxy-3-(2-hydroxy-phenyl)propanoic acid;
copper (II) salt of 3-amino-2-carboxy-3-(4-trifluoro methyl phenyl)propanoic acid;
copper (II) salt of 3-amino-2-carboxy-3-(4-hydroxy-3-methoxyphenyl)propanoic acid;
copper (II) salt of 3-amino-2-carboxy-3-(3,4-dimethoxyphenyl)propanoic acid;
copper (II) salt of 3-amino-3-(2-hydroxyphenyl)propanoic acid;
copper (II) salt of 3-amino-3-(4-hydroxy-3-methoxyphenyl)propanoic acid;
copper (II) salt of 3-amino-2-cyano-3-(4-hydroxyphenyl)propanoic acid;
copper (II) salt of 3-amino-2-cyano-3-(4-hydroxy-3-methoxy phenyl)propanoic acid;
copper (II) salt of 2-methoxysuccinic acid;
copper (II) salt of 2-ethoxysuccinic acid;
copper (II) salt of 3-(2-furyl)-2-carboxypropenoic acid;
copper (II) salt of 3-(2-thiazolyl)-2-carboxypropenoic acid;
copper (II) salt of 3-benzylidene-2-carboxypropenoic acid;
copper (II) salt of diallylmalonic acid;
copper (II) salt of ethylphenyn malonic acid;
copper (II) salt of bis(2-cyanoethyl)malonic acid;
copper (II) salt of N-morpholinemalonic acid;
copper (II) salt of N-benzyloxyimino malonic acid.

9. The process for the preparation of compounds having general formula (I) according to claim 1, characterized in that it comprises a reaction according to the reaction scheme A: 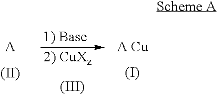
wherein A has the same meanings defined above and z has the value of 1 or 2.

10. Fungicidal compositions containing, as active principle, one or more compounds having general formula (I) according to claim 1.

11. The compositions according to claim 10, comprising other active principles compatible with the compounds having general formula (I), such as other fungicides, phyto-regulators, antibiotics, herbicides, insecticides, fertilizers.

12. The compositions according to claim 10, characterized in that the concentration of the active principles varies from 0.1% to 98%, preferably from 0.5% to 90%.

13. Use of the fungicidal compositions according to claim 10 for the control of phytopathogen fungi.

14. The use according to claim 1, characterized in that the phytopathogens are: Plasmopara viticola on vines; Phytophthora spp. on vegetables; Pyricularia oryzae on rice; Venturia inaequalis on apples; Peronospora tabacina on tobacco; Pseudoperonospora cubensis. on cucurbitaceous products; Bremia on salads, spinach; Alternaria spp. on tomatoes, potatoes.

15. A method for the control of phytopathogen fungi in agricultural crops by the application of the compounds having general formula (I) according to one of the claims 1-8 or by the application of a fungicidal composition according to claim 10.

16. The method according to claim 15, characterized in that the quantity of compound to be applied varies from 10 g to 5 kg per hectare.

17. The method according to claim 15, characterized in that the application takes place on all parts of the plant, for example on the leaves, stems, branches and roots, or on the seeds themselves before being planted, or on the ground in which the plant grows.

18. Use of the compounds having general formula (I) according to claim 1 for the control of fungal phytopathogens on non-living substrates, such as plastics, metals, textile fibers, glass, wood, paper, foams, bricks.

19. Use of a fungicidal composition according to claim 10 for the control of fungal phytopathogens on non-living substrates, such as plastics, metals, textile fibers, glass, wood, paper, foams, bricks.
